(19) United States
(12) Patent Application Publication
(10) Pub. No.: US 2014/0157022 A1
(43) Pub. Date: Jun. 5, 2014

(54) ELECTRONIC DEVICE AND METHOD FOR REDUCING CPU POWER CONSUMPTION

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: YA-GUO WANG, Shenzhen (CN); CHUN-CHING CHEN, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/958,650

(22) Filed: Aug. 5, 2013

(30) Foreign Application Priority Data
Dec. 4, 2012 (CN) 2012105129310

(51) Int. Cl. G06F 1/32

(52) U.S. Cl. CPC G06F 1/324
USPC 713/322; 713/300

(57) ABSTRACT

An electronic device includes a processing system, a storage unit for storing a table, an input unit for generating instruction in response to the operations of the user, and an actuating unit for generating an interrupt in response to the instructions to request the processing system to execute the instructions to perform desired functions. The table recording a relationship between an occupancy and a desired operating speed of the processing system. When the processing system is requested to execute instructions, the processing system calculates the occupancy and adjusts operating speed according to the calculated occupancy and the table. A method for reducing CPU power consumption is also provided.

### BACKGROUND

1. Technical Field

The present disclosure relates to electronic devices and method for reducing CPU power consumption.

2. Description of Related Art

With the development of the technologies of processing system, embedded processing systems are widely applied to portable electronic devices, such as portable DVD player. Currently, when the portable electronic devices are used, the processing systems have to continually detect whether an event occurs and executes corresponding instructions when an events occurs. However, the continual detecting process of the processing systems increase the power consumption of the processing systems, which may result in wasting of energy.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an electronic device in accordance with an embodiment.

FIG. 2 is an explanatory view of a table for recording a relationship between occupancy and operating speed in accordance with an embodiment.

FIG. 3 is a flowchart of a method for reducing CPU power consumption in accordance with an embodiment.

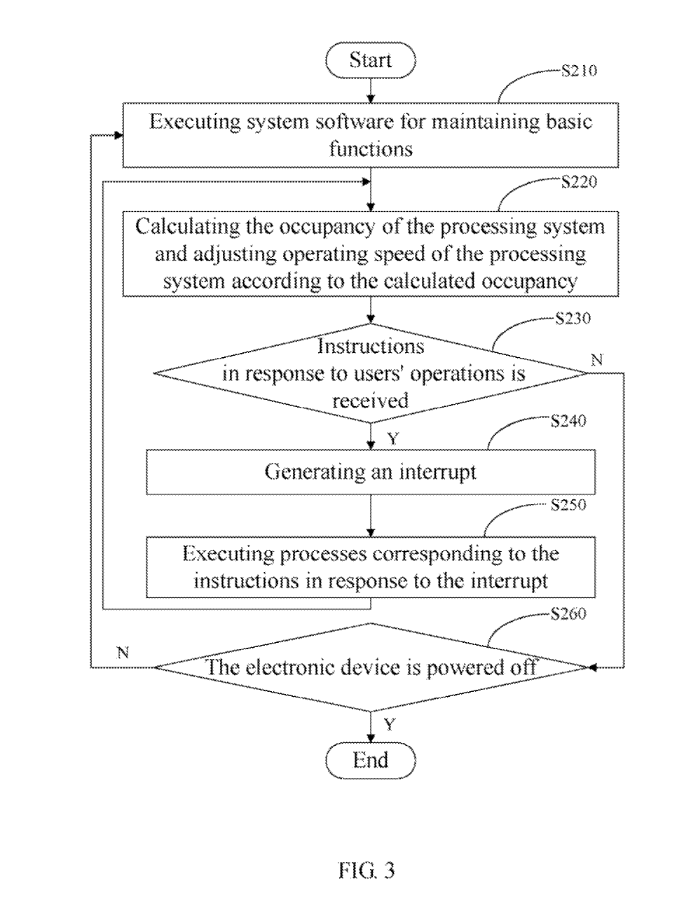

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

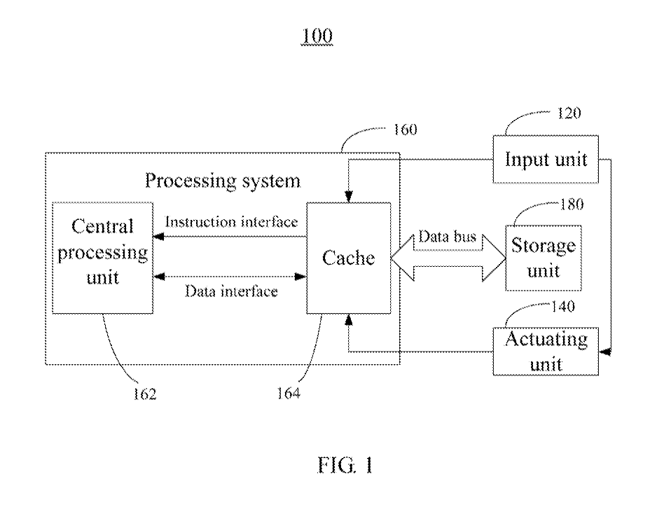

FIG. 1 shows an electronic device 100 having an embedded processing system. The electronic device 100 can be mobile phone, personal digital assistant (PDA), or the like. In the embodiment, the electronic device 100 is a portable digital versatile disc (DVD) player having an embedded processing system. The electronic device 100 includes an input unit 120, an actuating unit 140, a processing system 160, and a storage unit 180 electrically connected to the processing system 160 by data bus.

The processing system 160 in the embodiment is an embedded processing system. The processing system 160 operates instructions to perform desired operations during certain time period and waits for processes during other time period. Given a predetermined time interval, the ratio between the time of operating instructions and the predetermined time interval is defined as the occupancy of the processing system 160. Generally, the higher the occupancy of the processing system 160 is, the more power is consumed. For example, when the occupancy of the processing system 160 is within a range of between 0 and 30%, the processing system 160 runs in a minimum speed Vₘᵢₙ. When the occupancy of the processing system 160 is within a range of between 80% and 100%, the processing system runs in a maximum speed Vₘₐₓ. When the occupancy of the processing system 160 is within a range of between 30% and 80%, the processing system 160 runs in a speed V between Vₘₐₓ and Vₘᵢₙ.

The processing system 160 includes at least one independent central processing unit 162 (called core), a cache 164, and an Random Access Memory (RAM) not shown, where the processing system 160 stores temporary data. The cache 164 is electrically connected to the central processing unit 162 via a high-speed interface including an instruction interface and a data interface. The cache 164 is connected between the central processing unit 162 and peripheral equipment, such as input device, display, DVD or the like. While running, the processing system 160 obtains instructions and/or data from the storage unit 180, and further sends the obtained instructions and/or data to the cache 164, the central processing unit 162 accesses the instructions and/or data from the cache 164 to achieve high speed.

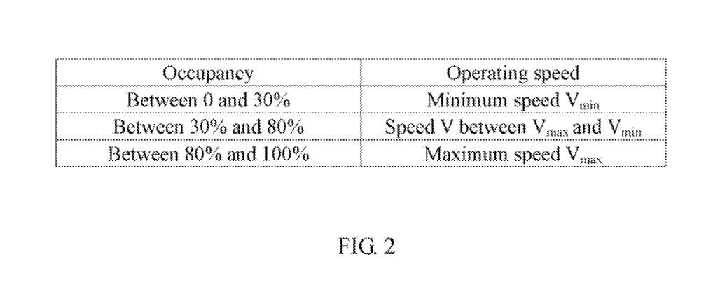

The storage unit 180 stores system software, application software, and driver software for hardware device, and the like. Referring to FIG. 2, the storage unit 180 further stores a table for recording a relationship between the occupancy and the desired operating speed of the processing system 160. In the embodiment, the table records different speeds. Each speed corresponds to a predetermined range of occupancy.

The processing system 160 obtains the occupancy in real time and obtains a desired operating speed corresponding to the obtained occupancy based on the table, and further adjusts the current operating speed to be the desired operating speed. The processing system 160 changes the data exchange rate between the central processing unit 162 and the cache 164 to adjust the operating speed. For example, when the occupancy of the processing system 160 is in a range of between 0 and 30%, the processing system 160 turns off the instruction and data interfaces, and further increases read/write delay between the central processing unit 162 and the cache 164, so as to adjust the processing system 160 to run in a relativity low speed. When the occupancy of the processing system 160 is in a range of between 80 and 100%, the processing system 160 turns on the instruction and data interfaces, and further decreases read/write delay between the central processing unit 162 and the cache 164, so as to adjust the processing system 160 to run in a relativity high speed. In the embodiment, the read/write delay between the central processing unit 162 and the cache 164 is increased/decreased by adjusting settings of the processor register (not shown).

The input unit 110 responses to user's operation to generate instructions for controlling the electronic device 100 to perform desired functions. The input unit 110 can be a number of keys and/or buttons, or a touch panel mounted on the electronic device 100, and can also be a remote device for remotely controlling the electronic device 100.

The actuating unit 140 detects whether the input unit 120 generates instructions, and generates an interrupt if the input unit 120 generates the instructions. The actuating unit 140 further transmits the interrupt to the processing system 160 to request the processing system 160 to execute processes corresponding to the instructions. If the input unit 120 does not generate instructions, no interrupt is generated, and the actuating unit 140 continues to detect whether the input unit 120 generates instructions.

When the processing system 160 executes processes corresponding to the instructions generated by the input unit 120, the processing system 160 recalculates the occupancy and further adjusts operating speed according to the recalculated occupancy and the table. As a result, when no interrupt is generated in response to instructions generated by the input unit 120, the processing system 160 has not detected processes being executed continually, and the occupancy for detecting process can be avoided, thus CPU power consumption is reduced.

For better understood, an operation of pressing one of keys/buttons is taken as an example for explaining the principle of the electronic device 100.

After the electronic device 100 is powered, if no application software is executed or no instructions are generated by the input unit 120, the processing system 160 only executes system software for maintaining basic functions of the electronic device 100, at this time, the occupancy of the processing system 160 is generally the lowest. Thus, the operating speed is a relatively low speed correspondingly. When keys/buttons are pressed, the input unit 120 generates instructions, and the actuating unit 140 generates the interrupt in response to the instructions to request the processing system 160 to execute processes corresponding to the instructions. After executing the processes, the processing system 160 recalculates the occupancy and further adjusts operating speed according to the recalculated occupancy and the table. As a result, the processing system 160 has not to detect processes being executed continually, and the occupancy for detecting process can be avoided. Furthermore, the processing system 160 is capable of calculating the occupancy in real time and adjusting the operating speed according to the table, whereby CPU power consumption is reduced.

FIG. 2 shows a method for reducing CPU power consumption. The method is applied in the electronic device 100 having a storage unit 180. A table for recording a relationship between the occupancy and desired operating speed of the processing system 160 is stored in the storage unit 180. The table in the embodiment records different speeds. Each speed corresponds to a predetermined range of occupancy. The method includes the following steps:

In step S210, the processing system 160 executes system software for maintaining basic functions after the electronic device 100 is powered on.

In step S220, the processing system 160 calculates the occupancy and adjusts operating speed according to the calculated occupancy. In the embodiment, the processing system 160 obtains a desired operating speed corresponding to the obtained occupancy based on the table, and further adjust the current operating speed to be the desired operating speed.

In step S230, the actuating unit 140 detects whether the input unit 120 generates instructions. If yes, the procedure goes to step S240. If no, the procedure goes to step S260.

In step S240, the actuating unit 140 generates an interrupt.

In step S250, the processing system 160 executes processes corresponding to the instructions in response to the interrupt, and further recalculates the occupancy and adjusts operating speed according to the recalculated occupancy and the table, the procedure returns to S220.

In step S260, the processing system 160 determines whether the electronic device 100 is power off. If yes, the procedure ends. If not, the procedure returns to step S210.

Although information as to, and advantages of, the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An electronic device comprising;
a processing system;
a storage unit for storing a table, wherein the table recording a relationship between an occupancy and an operating speed of the processing system;
an input unit for generating instruction in response to user's operations; and
an actuating unit for generating an interrupt in response to the instructions to request the processing system to execute the instructions to perform desired functions;
wherein when the processing system is requested to execute instructions, the processing system calculates the occupancy and adjusts operating speed thereof according to the calculated occupancy and the table.

2. The electronic device of claim 1, wherein the processing system comprises at least one independent central processing unit and a cache; the central processing unit accesses the instructions and/or data from the cache to achieve high speed.

3. The electronic device of claim 2, wherein the processing system adjusts the operating speed by changing the data exchange rate between the central processing unit and the cache.

4. The electronic device of claim 1, wherein the processing system is an embedded processing system.

5. A method for reducing CPU power consumption applied in an electronic device comprising a processing system, the method comprising:
providing a table for recording a relationship between the occupancy and desired operating speed of the processing system;
generating instructions in response to user's operations;
generating an interrupt to request the processing system to execute the instructions to perform desired functions in response to the instructions; and
calculating the occupancy and adjusting operating speed according to the calculated occupancy and the table.

6. The method according to claim 5, wherein the processing system comprises at least one independent central processing unit and a cache; the central processing unit accesses the instructions and/or data from the cache to achieve high speed.

7. The method according to claim 6, wherein the processing system adjusts the operating speed by changing the data exchange rate between the central processing unit and the cache.

8. The method of claim 5, wherein the processing system is embedded processing system.
